(19) United States
(12) Patent Application Publication
(10) Pub. No.: US 2017/0230809 A1
(43) Pub. Date: Aug. 10, 2017

(54) METHOD AND USER EQUIPMENT FOR PROCESSING REQUEST FOR EMERGENCY CALL

(71) Applicant: Samsung Electronics Co., Ltd, Gyeonggi-do (KR)

(72) Inventors: Jayashankara DM, Bangalore (IN); Lalith KUMAR, Bangalore (IN); Ricky KAURA, Bangalore (IN); Saurabh SHAURAN, Bangalore (IN)

(21) Appl. No.: 15/519,393

(22) PCT Filed: Oct. 14, 2014
(86) PCT No.: PCT/KR15/10844

§ 371 Date: Apr. 14, 2017

(30) Foreign Application Priority Data
Oct. 14, 2014 (IN) 5150/CHE/2014

(51) Int. Cl. H04W 4/22; H04W 88/02; H04W 8/18; H04W 24/08; H04W 76/00; H04M 11/04

(52) U.S. Cl. CPC H04W 4/22; H04W 76/007; H04M 11/04; H04W 8/18; H04W 24/08; H04W 88/02; H04W 76/027

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The method for processing a request for an emergency call comprises performing at least one of ignoring a reject cause received from a network, and providing highest priority to the emergency call in a call priority order defined for the UE after receiving the request for the emergency call.

### TECHNICAL FIELD

The embodiments herein generally relate to the field of wireless mobile communications and more particularly to handling of emergency call in wireless mobile communication networks.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Wireless mobile communication network enables a multitude of services such as voice calls, Short Message Service (SMS), Multimedia Messaging Service (MMS), internet access, emergency call and so on. These services are provided by a User Equipment (UE) such as a mobile phone, a tablet, a wearable device in accordance with standards laid down by the Third Generation Partnership Project (3GPP). Specifications in the 3GPP standard are being seamlessly amended to achieve effective bandwidth utilization in a network for the wireless mobile communications, improve data speed, enhances user experience and so on. Providing best possible Quality of Service (QoS) for various features provided to a user of the UE largely contributes towards enhancing the user experience.

### DISCLOSURE OF INVENTION

### Technical Problem

The emergency call service enables a user of the UE to call predefined emergency numbers with or without being registered to a service provider's network. One of the most critical requirements for the emergency call service is to reduce cases of emergency call drop, emergency call failure or emergency call delay to a minimum. However, with current methods for handling emergency call, in accordance with the 3GPP standards, for certain scenarios the cases of call drop, call failure or call delay may be considerable. For example, consider a scenario when a control plane (CP) layer in the UE initiates specific procedures (for example, a Tracking Area Update (TAU) procedure) with a TAU request to the network for reasons as specified in 3GPP TS 24.301 specification (for example, due to T3412 timer expiry etc). In case, at same time if the CP receives the emergency call request, then the emergency call is blocked till the TAU procedure is completed. Thus the emergency call is put on hold. Further, if the TAU request is rejected by the network with a TAU reject for cause values #9, #10 or #40, as per a reject cause handling the UE is supposed to initiate an attach procedure. Thus even though the emergency call is pending, the UE initiates the attach procedure and the emergency call is further put on hold. Once the UE gets attach accept from the network, only then the UE initiates extended service request (ESR) procedure to move to 2G/3G Radio Access Technology (RAT) so that the emergency call procedures following Mobility Management (MM) and Call Control (CC) procedures may be initiated. Additionally, if the initiated attach request procedure is unsuccessful because of Attach reject from network or due to some temporary network abnormal conditions, as specified in specification 24.301, then this further delays the emergency call or may even lead to emergency call set up failure.

In another scenario, if for the initiated TAU request, the UE receives the TAU reject from the network with cause values #11, #13. As per the reject cause handling the UE is supposed to initiate a public land mobile network (PLMN) Search. Thus, even though the emergency call is pending, the UE initiates the PLMN Search process. Moreover, till the PLMN search process is completed, the emergency call is either delayed or rejected.

In another scenario, the TAU procedure may be initiated towards the network by the CP of the UE due to the emergency call request from AP of the UE. Even in such cases, where the specific procedure is initiated due to the emergency call initiation, if this specific procedure fails and if the UE continues to execute corresponding failure actions then this delays the emergency call procedure. Similarly, in case for the TAU procedure initiated due to the emergency call fails due to abnormal case corresponding to the network, the emergency call procedure at the UE end gets delayed.

In another scenario, when a paging is received by the UE for an incoming Mobile Terminated (MT) call, then in accordance with current 3GPP specification the UE responds to the paging with paging response. Further, the UE moves to a ‘WAIT FOR NETWORK COMMAND’ state and starts a timer T3240. During this period, if a Connection Management (CM) layer in the UE initiates a CM service request for the emergency call, then in accordance to the current specification of the 3GPP standard this CM service request can either be rejected or delayed until the WAIT FOR NETWORK COMMAND is state is left by the UE. This is due to preference given to the MT Call in the current specification of the 3GPP standard. Further, whenever the initiated T3240 expires, the UE aborts the Radio Resource (RR) connection and moves to idle state. Thus, this may further lead to emergency call set up failure.

However, the emergency call needs to be processed with high priority and minimum call drop or call failure rates; else the purpose of emergency call may not be served.

The principal object of the embodiments herein is to provide a method and a User Equipment (UE) for processing a pending request for an emergency call, when a specific procedure reject cause is received by the UE from a network, or procedures corresponding to a Mobile Terminated (MT) call are performed by the UE.

Another object of the embodiments herein is to provide a method for processing the request and continuing procedures for the emergency call by aborting procedures associated with handling of the reject cause.

Another object of the embodiments herein is to provide a method for processing the request and continuing procedures for the emergency call by providing highest priority to the emergency call and terminating procedures corresponding to the MT call.

### Solution to Problem

In view of the foregoing, an embodiment herein provides a method for processing a request for an emergency call in a User Equipment (UE). The method comprises performing at least one of ignoring a reject cause received from a network, and providing highest priority to the emergency call in a call priority order defined for the UE after receiving the request for the emergency call. Further, the method comprises continuing procedures for the emergency call to process the request.

Embodiments further disclose a User Equipment (UE) for processing a request for an emergency call. Further, the UE comprises an integrated circuit further comprising at least one processor and at least one memory having a computer program code within the circuit. Further, the at least one memory and the computer program code with the at least one processor cause a Control Plane (CP) of the UE to perform at least one of ignoring a reject cause received from a network, and providing highest priority to the emergency call in a call priority order defined for the UE after receiving the request for the emergency call. Further, the CP is configured to continue procedures for the emergency call to process the request.

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments of this invention are illustrated in the accompanying drawings, through out which like reference letters indicate corresponding parts in the various figures. The embodiments herein will be better understood from the following description with reference to the drawings, in which:

FIG. 1 illustrates a plurality of components of a User Equipment (UE) for processing a request for an emergency call, according to embodiments as disclosed herein;

FIG. 2 illustrates an example sequence diagram for continuing procedures for the emergency call by ignoring a reject cause received by the UE from a network, according to embodiments as disclosed herein;

FIG. 3 illustrates an example sequence diagram for continuing procedures for the emergency call by providing highest priority to the emergency call in a call priority order defined for the UE, according to embodiments as disclosed herein; and

FIG. 4 is a flow diagram illustrating a method for processing the request for the emergency call when the reject cause or a WAIT FOR NETWORK COMMAND state is detected by the UE, according to the embodiments herein as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein achieve a method and a User Equipment (UE) for processing a request for an emergency call when a reject cause is received by the UE from a network, or procedures corresponding to a Mobile Terminated (MT) call are performed by the UE. The UE may receive the reject cause from the network, in accordance with procedures specified in specification 24.301 and/or specification 24.008 of a Third Generation Partnership Project (3GPP). In an embodiment, in such scenario, the method includes processing the request received for the emergency call by ignoring the reject cause. Further, the method includes aborting procedures associated with handling of the reject cause so as to continue with the emergency call. Thus, the method reduces the emergency call delays or emergency call failures.

In an embodiment, the emergency call may be a Circuit Switched (CS) call or a Packet switched emergency call and is handled accordingly.

In an embodiment, the UE actions defined for handling the pending emergency call request when the reject cause is received from the network can be equally applied for a normal call request received (for example, a Circuit Switch Fall Back (CSFB) Call request). Thus, increasing the normal call success rate.

The UE may detect a WAIT FOR NETWORK COMMAND state due to procedures performed by the UE corresponding to a Mobile Terminated (MT) call. In an embodiment, in such scenarios where the request for the emergency call is pending and UE detects the WAIT FOR NETWORK COMMAND state, the method includes providing highest priority to the emergency call and terminating procedures corresponding to the MT call. Further, the method includes continuing with procedures associated with the emergency call.

Thus, the method includes defining a call priority order in the UE with descending priority order as the emergency call, a high priority access, the MT call, and the Mobile Originated (MO) call.

In an embodiment, the UE is a mobile phone, a tablet, a personal digital assistant, a laptop, a wearable device and any other electronic device capable of wireless mobile communication.

In an embodiment, the network can be a Universal Mobile Telecommunication System (UMTS), Long Term Evolution (LTE), LTE advanced, GSM EDGE Radio Access Network (GERAN), UMTS Terrestrial Radio Access Network (UTRAN) advanced or the like.

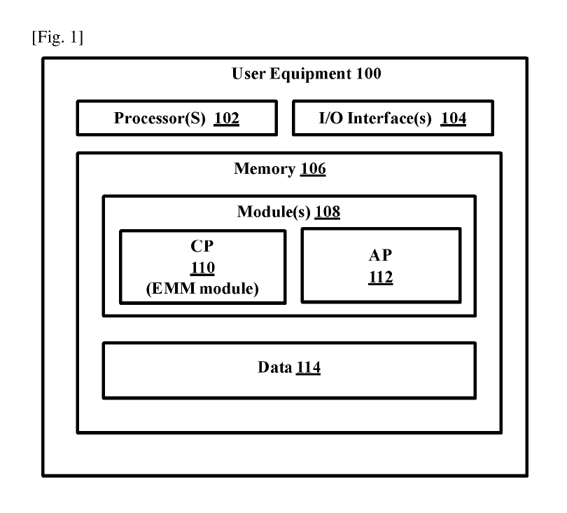

Referring now to the drawings, and more particularly to FIGS. 1 through 4, where similar reference characters denote corresponding features consistently throughout the figures, there are shown embodiments.

FIG. 1 illustrates a plurality of components of a User Equipment (UE) for processing a request for an emergency call, according to embodiments as disclosed herein.

Referring to FIG. 1, the UE 100 is illustrated in accordance with an embodiment of the present subject matter. In an embodiment, the UE 100 may include at least one processor 102, an input/output (I/O) interface 104 (herein a configurable user interface), a memory 106, and so on. The at least one processor 102 may be implemented as one or more microprocessors, microcomputers, microcontrollers, digital signal processors, central processing units, state machines, logic circuitries, and/or any devices that manipulate signals based on operational instructions. Among other capabilities, the at least one processor 102 is configured to fetch and execute computer-readable instructions stored in the memory 106.

The I/O interface 104 may include a variety of software and hardware interfaces, for example, a web interface, a graphical user interface, and the like. The I/O interface 104 may allow the UE 100 to communicate with other devices. The I/O interface 104 may facilitate multiple communications within a wide variety of networks and protocol types, including wired networks, for example, Local Area Network (LAN), cable, etc., and wireless networks, such as wireless local area network (WLAN), cellular, Device to Device (D2D) communication network, Wi-Fi networks and so on.

The modules 108 include routines, programs, objects, components, data structures, etc., which perform particular tasks, functions or implement particular abstract data types. In one implementation, the modules 108 may include a Communication Protocol layer (CP 110) that includes an entitlement management message (EMM) module, and an Application Protocol layer (AP 112).

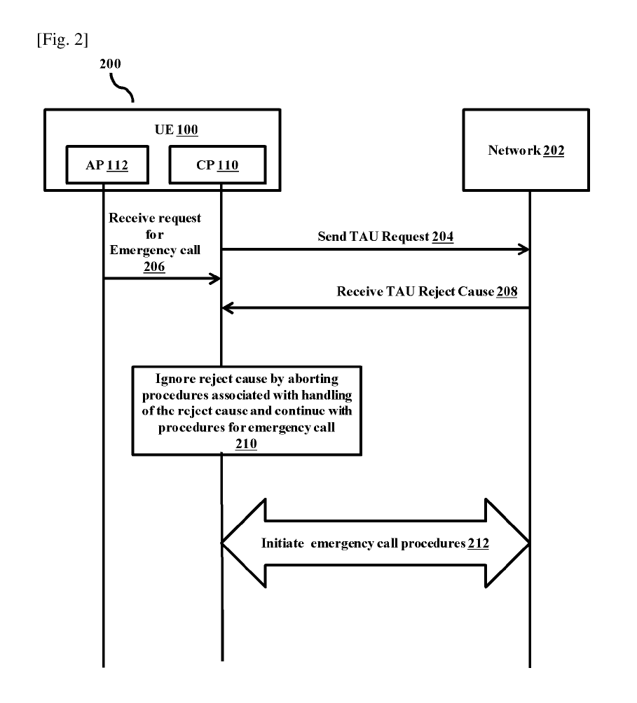

In an embodiment, the CP 110 may receive the request for the emergency call from the AP 112 when the CP 110 is busy with performing specific procedures such as Tracking Area Update (TAU) request, Region Area Update (RAU) request, Location Area update (LAU) request or the like. In such scenarios when the reject cause is received from the network and the request for the emergency call is pending, the CP 110 can be configured to abort the procedures associated with handling of the reject cause. Further, the CP 110 can be configured to continue with procedures for the setting up of the emergency call and successfully process the received request for the emergency call. The embodiment is explained with an example sequence diagram and example cases in conjunction with FIG. 2.

In an embodiment, the CP 100 can be configured to apply actions defined for processing the pending emergency call request for processing the normal call request when the reject cause is received from the network when the normal call request is pending. Thus, improving the normal call success rate.

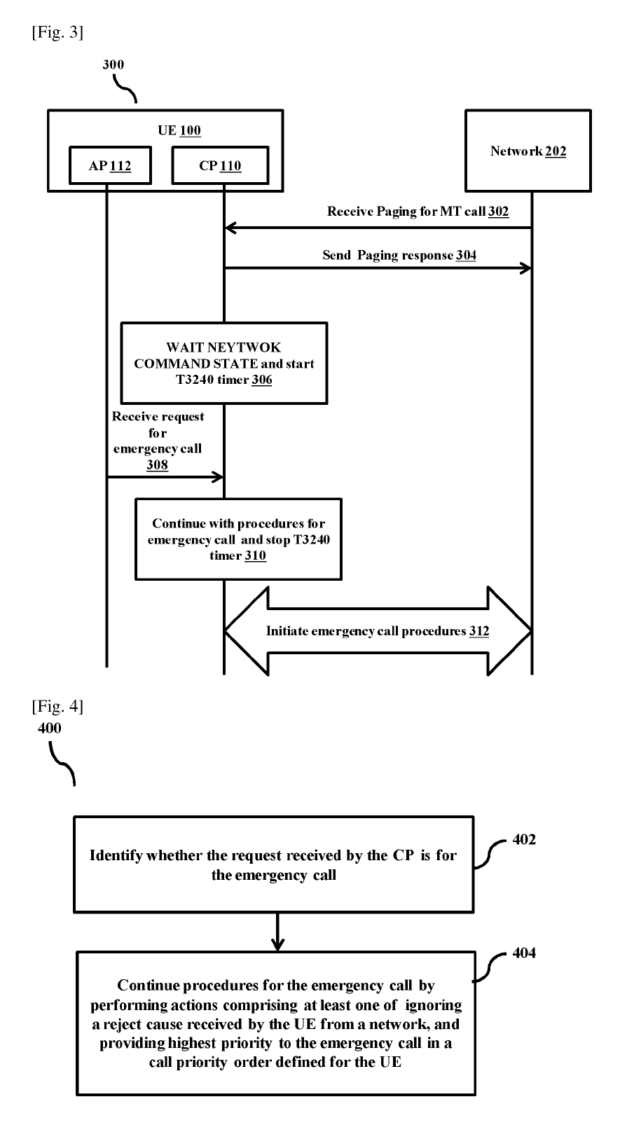

In an embodiment, the CP 110 may receive the request for the emergency call when the CP 110 is busy performing procedures for an MT call. Thus, when the request for the emergency call is received, the CP 110 may identify the UE 100 is in the WAIT FOR COMMAND state with a timer T3240 being initiated in accordance with the specification in the 3GPP standard. In such scenarios when UE 100 is in the WAIT FOR COMMAND state with the timer 3240 being initiated and the request for the emergency call is pending, the CP 110 can be configured to stop the timer T3240 and terminate procedures for the MT call. Further, the CP 110 can be configured to provide highest priority to the emergency call and continue with procedures for the setting up of the emergency call. The embodiment is explained with an example sequence diagram in conjunction with FIG. 3. Thus, the a call priority order in the UE 100 is defined with descending priority order as the emergency call, the high priority access, the MT call, and the Mobile Originated (MO) call.

The modules 108 may include programs or coded instructions that supplement applications and functions of the UE 100. The data 112, amongst other things, serves as a repository for storing data processed, received, and generated by one or more of the modules 108. Further, the names of the other components and modules of the UE 100 are illustrative and need not be construed as a limitation.

FIG. 2 illustrates an example sequence 200 diagram for continuing procedures for the emergency call by ignoring a reject cause received by the UE from a network 202, according to embodiments as disclosed herein. In an embodiment, the UE 100 communicates with the network 202. The CP 110 of the UE 100 sends (204) the TAU request and receives (208) the TAU reject cause from the network 202. The TAU reject cause can be reject cause #9, #10, #140 or the like in accordance with the 24.301 specification. However, since a received (206) emergency call request is pending, the CP 110 ignores (210) the reject cause and continues with procedures for the emergency call. Further, the CP 110 initiates (212) the emergency call procedures to process the request for the emergency call.

Plurality of example cases when the specific procedure reject is received and the manner CP 110 of UE 100 may be configured to handle the reject causes for each example case to continue emergency call procedures is provided below.

Case 1: If the specific procedure (for example, combined TAU or combined RAU) is successful but only for “Evolved Packet Services (EPS) Services” or “PS Services” and the CS registration is rejected. For example, reject cause such as #16 (MSC temporarily not reachable); or #17 (Network failure) as specified under specification 24.008 and 24.301. In such scenario, if the CS emergency call is pending UE 100 (CP 110) may be configured to proceed with appropriate MM and CC procedures to initiate call setup procedure.

Case 2: If the CS emergency call is pending when specific procedure reject is received or specific procedure faces abnormal cases as specified in 24.008 or 24.301 and the UE 100 is in LTE RAT, UE 100 (CP 110) may be configured to select 2G/3G RAT and proceed with appropriate MM and CC procedure to initiate the CS emergency call.

Case 3: If the CS emergency call is pending when specific procedure reject is received or specific procedure faces abnormal cases as specified in 24.008 or 24.301 and the UE 100 is in UMTS or GSM RAT, UE 100 (CP 110) may be configured to proceed with appropriate MM and CC procedure to initiate CS emergency call.

Case 4: If a Packet switched (PS) emergency call is pending when specific procedure reject is received or specific procedure faces abnormal cases as specified in 24.008 or 24.301, the UE 100 (CP 110) may be configured to initiate Packet data Protocol (PDP) activation procedure or emergency attach to establish the emergency call.

Case 5: In an embodiment, whenever specific procedure reject (for example, the TAU reject) is received with causes #9, #10 or #40 and if the CS emergency call is pending, UE 100 instead of performing attach procedure maybe configured to attempt to select the GERAN or UMTS Terrestrial Radio Access Network (UTRAN) radio access technology and proceeds with the appropriate MM and CC specific procedures.

FIG. 3 illustrates an example sequence 300 diagram for continuing procedures for the emergency call by providing highest priority to the emergency call in a call priority order defined for the UE 100, according to embodiments as disclosed herein. In an embodiment, the UE 100 communicates with the network 202.

The CP 110 receives (302) a paging for the MT call. The CP 100 sends a (304) a paging response to the received paging. In accordance to the 3GPP standard, the CP 110 sets the state of the UE 110 to WAIT NETWORK COMMAND STATE and starts (306) T3240 timer. The CP 110 receives (308) the request for the emergency call. Thus, in such scenario there is a collision between the MT call and emergency call (also referred as MO emergency call). Since, the emergency call request is pending, the CP 110 stops (310) the timer T3240 and continues with procedures for emergency call. Thus, the CP 110 provides highest priority to the emergency call and terminates procedures corresponding to the MT call.

Further, the CP 110 initiates (312) the emergency call procedures to process the request for the emergency call.

FIG. 4 is a flow diagram illustrating a method 400 for processing the request for the emergency call when the reject cause or a WAIT FOR NETWORK COMMAND state is detected by the UE, according to the embodiments herein as disclosed herein. At step 402, the method 400 includes allowing the CP 110 to detect that a call request received by the CP is for the emergency call. At step 402, the method 400 includes allowing the CP 110 to continue procedures for the emergency call by performing one or more actions. The actions include ignoring the reject cause received by the UE 100 from the network 202 or providing highest priority to the emergency call in the call priority order defined for the UE 100. The ignoring of the reject cause comprises aborting procedures associated with handling of the reject cause. The reject cause may be received by the CP 110 in accordance with procedures specified in specification 24.301. Further, the method includes defining the call priority order with descending priority as the emergency call, the high priority access, the MT call, and the Mobile Originated (MO) call. Providing highest priority to the emergency call includes stopping a T3240 timer initiated by the UE 100 during the WAIT NETWORK COMMAND state of the UE 100 while performing procedures corresponding to the MT call. The steps of method 400 are performed as explained in the example sequence diagram of FIG. 2 and FIG. 3 and not repeated for brevity. The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIG. 1 through FIG. 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Therefore, while the embodiments herein have been described in terms of preferred embodiments, those skilled in the art will recognize that the embodiments herein can be practiced with modification within the spirit and scope of the embodiments as described herein.

1. A method for processing a request for an emergency call in an user equipment (UE), the method comprising:
performing, by a communication protocol layer (CP) of the UE, at least one of ignoring a reject cause received from a network;
providing a highest priority to the emergency call in a call priority order defined for the UE after receiving the request for the emergency call; and
continuing procedures for the emergency call to process the request.

2. The method as claimed in claim 1, wherein ignoring the reject cause comprises aborting procedures associated with handling of the reject cause.

3. The method as claimed in claim 1, wherein providing highest priority to the emergency call comprises stopping a timer initiated by the UE during a wait network command state of the UE while performing procedures corresponding to a mobile terminated (MT) call.

4. The method as claimed in claim 3, wherein the timer includes a T3240 timer.

5. The method as claimed in claim 1, wherein the call priority order, in descending priority order, comprises the emergency call, a high priority access, the MT call, and a mobile originated (MO) call.

6. The method as claimed in claim 1, wherein the emergency call is blocked until a tracking area update (TAU) procedure is completed.

7. The method as claimed in claim 1, wherein the reject cause includes a tracking area update (TAU) reject cause.

8. A user equipment (UE) for processing a request for an emergency call, wherein the UE comprises:
an integrated circuit further comprising at least one processor;
at least one memory having a computer program code within the circuit;
the at least one memory and the computer program code with the at least one processor cause a control plane (CP) of the UE to:
perform at least one of ignoring a reject cause received from a network, and providing highest priority to the emergency call in a call priority order defined for the UE after receiving the request for the emergency call; and
continue procedures for the emergency call to process the request.

9. The UE as claimed in claim 8, wherein the CP is configured to ignore the reject cause by aborting procedures associated with handling of the reject cause.

10. The UE as claimed in claim 8, wherein the CP is configured to provide highest priority to the emergency call by stopping a timer initiated by the UE during a wait network command state of the UE while performing procedures corresponding to a mobile terminated (MT) call.

11. The UE as claimed in claim 10, wherein the timer includes a T3240 timer.

12. The UE as claimed in claim 8, wherein the call priority order, in descending priority order, comprises the emergency call, a high priority access, the MT call, and a mobile originated (MO) call.

13. The UE as claimed in claim 8, wherein the emergency call is blocked until a tracking area update (TAU) procedure is completed.

14. The UE as claimed in claim 8, wherein the reject cause includes a tracking area update (TAU) reject cause.
